(19) United States
(12) Patent Application Publication
(10) Pub. No.: US 2006/0072867 A1
(43) Pub. Date: Apr. 6, 2006

(54) Optical transmitter

(76) Inventor: Toru Kawagishi, Kanagawa (JP)

Correspondence Address: SMITH, GAMBRELL & RUSSELL, LLP, 1850 M STREET, N.W., SUITE 800, WASHINGTON, DC, 20036, US

(21) Appl. No.: 11/235,525

(22) Filed: Sep. 27, 2005

(30) Foreign Application Priority Data
Sep. 28, 2004 (JP) P. 2004-282421

(51) Int. Cl. G02F 1/295

(52) U.S. Cl. 385/4

(57) ABSTRACT

The present invention provides an optical transmitter that compensates the thermal tracking error. The transmitter comprises a temperature feedback loop including temperature controller that controls the temperature of the laser diode to coincide with the reference temperature by the thermo-electric device. The reference temperature reflects the thermal tracking error that depends on the ambient temperature and that of the target temperature of the laser diode. The transmitter installs a lookup table for providing the reference temperature. The lookup table is rewritten taking the long-term deterioration of the laser diode into account, which is reflected in the increase of the bias current and the forward voltage of the laser diode.

### BACKGROUND OF THE INVENTION

1. Field of the Invention

The present invention relates to an optical transmitter.

2. Related Prior Art

Japanese patent published as H11-163462 has disclosed a controller to stabilize the emission wavelength of the laser diode, hereinafter denoted as LD. This controller corrects the drift of the emission wavelength, which is due to the increase and the decrease of the driving current fort the LD, in a long period to stabilize the wavelength thereof in a superior precision. The controller includes a current detector, a normalizer, and a reference generator. The current detector detects the magnitude of the driving current for the LD, which is adjusted by the control circuit for the optical output. The normalizer normalizes the current detected by the current detector. The reference generator outputs a target temperature for the LD, which depends on the normalized current. The controller further includes a temperature sensor that outputs a signal corresponding to a present temperature of the LD. The current controller, which is provide in the controller, adjusts the current flowing in the thermo-electric device so as to close the temperature sensed by the temperature sensor to the target temperature.

Another Japanese patent published as H06-283797 has disclosed a laser transmitter. This laser transmitter stabilizes the temperature of the LD by sensing the temperature of the heat sink on which the LD is mounted. Moreover, since the emission wavelength of the LD depends on the temperature of the active layer thereof, this laser transmitter evaluates the temperature of the active layer by monitoring the current flowing therein and the voltage appeared between the anode and the cathode thereof. The temperature of the heat sink is so adjusted based on this evaluation.

These control disclosed above references monitor the temperature of the LD by the thermistor, or a device equivalent to the thermistor, disposed closed to the LD to stabilize the temperature of the thermistor, which is the so-called indirect monitoring. Therefore, a discrepancy is inevitable in the temperature between the LD and the thermistor, which shifts the emission wavelength of the LD from the target value. This phenomenon is known as the thermal tracking error. One reason for causing the tracking error, in other words, the reason for causing the temperature difference between the LD and the thermistor, is the recurrence of the heat dissipated from the radiating surface of the thermo-electric device to the region around the thermistor mounted on the endotherm surface of the cooler when the temperature difference between the LD and the ambient is large, namely, the temperature difference between the radiating surface and the endotherm surface of the thermoelectric cooler.

The controller in the former Japanese patent sets the temperature thereof based on the change of the driving current which is caused by the long-term deterioration of the LD. Accordingly, the controller may compensate the wavelength change due to the deterioration of the LD by setting the temperature thereof. On the other hand, the controller in the latter Japanese patent makes the temperature of the heat sink and the optical output power of the LD constant. The long-term deterioration of the LD increases the forward bias voltage thereof because the resistance of the active layer increases. Moreover, the conversion efficiency from electrical to optical signals also degrades as the long-term deterioration of the LD, which increases the current to maintain the optical output power. Accordingly, the power consumption of the LD increases, which raises the temperature of the active layer and shifts the emission wavelength thereof. The controller in the latter Japanese patent, to suppress this phenomenon mentioned above, estimates the temperature of the active layer by monitoring the forward voltage and the current of the LD, and controls the temperature of the heat sink based on thus monitored values. That is, the controller operates to compensate the temperature rising of the active layer due to the increasing of the power consumption by the long-term deterioration.

However, these controllers disclosed in patents mentioned above only control the target temperature of the LD to compensate the long-term deterioration, not compensates the tracking error itself. Therefore, an object of the present invention is to provide an optical transmitter capable of compensating the tracking error.

### SUMMARY OF THE INVENTION

One feature of the present invention relates to the architecture of an optical transmitter. The optical transmitter according to the present invention comprises a laser diode (LD), a temperature sensor, a thermo-electric device a first generator, a second generator and a temperature controller. The LD emits light with an emission wavelength at a temperature that is controlled by the thermoelectric device and is monitored by the temperature sensor. The first generator generates the reference temperature. The temperature controller controls the temperature of the LD to coincide with the reference temperature. The second generator generates a correction temperature based on the ambient temperature and, according to the present invention; the reference temperature is corrected by the correction temperature so as to compensate a thermal tracking error of the LD with respect to the ambient temperature.

Since the reference temperature of the invention, the temperature of the LD being controlled to coincide thereto, reflects the compensation of the thermal tracking error, the emission wavelength of the LD may be adjusted in a wide range of the temperature. In particular, even when the target temperature for the LD is widely different to the ambient temperature, the desired emission wavelength may be precisely obtained.

The second generator may provide a table, a lookup table, for storing the correction temperature with respect to the ambient temperature. By storing the correction-temperature in the table, the second generator may read out the correction value at the present ambient temperature, and the first generator may correct the target temperature, to which the temperature controller sets the temperature of the thermo-electric device under a condition of no thermal tracking error, by adding the correction temperature thereto or by extracting the correction temperature therefrom.

The optical transmitter of the invention may further provide a bias driver for providing a bias current to the LD. The bias drive may output a current monitoring signal to the second generator, which corresponds to the bias current. The bias driver may further output a voltage monitoring signal to the second generator. The voltage monitoring signal corresponds to the forward bias voltage of the LD. The second generator may be configured to renew the lookup table based on the current monitoring signal or the voltage monitoring signal, or both of the current and voltage monitoring signals.

The LD typically shows the long-term deterioration, which is reflected in the increase of the bias current to obtain the optical output power at the beginning of the lasing, and the increase of the forward bias voltage that is caused by the increase of the intrinsic resistance of the active layer of the LD. The optical transmitter of the invention may correct this long-term degradation of the LD by reflecting the increase of the bias current and the forward voltage within the correction temperature.

Another feature of the present invention relates to a method for controlling the LD in the optical transmitter. The method includes steps of; (1) setting a target temperature in the first generator, the target temperature means that a temperature to which the temperature controller sets the temperature of the thermo-electric device under the condition with no thermal tracking error, (2) generating the correction temperature based on an ambient temperature, (3) calculating the reference temperature from the target temperature and the correction temperature, and (4) controlling the temperature of the thermo-electric device so as to coincide with the reference temperature.

The step for generating the correction temperature may include a step for reading the correction temperature from the lookup table in which the correction temperature is stored with respect to the ambient temperature. The step for generating the correction temperature may include a step for calculating the correction temperature based on an nth polynomial by using the ambient temperature and variables stored in the table in advance to the calculation. This calculation provides a precise correction temperature because the limited size of the lookup table only provides correction temperatures with wide interval of the ambient temperature.

The lookup table may be renewed based on the current monitoring signal, the voltage monitoring signal or both of the current and voltage monitoring signals to compensate the long-term degradation of the LD. The renewal of the lookup table may be carried out by calculating a difference in the current monitoring signal, in the voltage monitoring signal, or both of the current and monitoring signals between a present magnitude and a magnitude at the beginning of the lasing. Thus, by renewing the lookup table, the correction signal always reflects the compensation amount of the thermal tracking error and the long-term deterioration of the LD, thereby realizing the precise and stable controlling of the emission wavelength of the LD.

### BRIEF DESCRIPTION OF DRAWINGS

FIG. 1 is a block diagram of an optical transmitter according to the first embodiment of the present invention;

FIG. 2A shows a behavior of the emission wavelength of the laser diode against temperatures that includes the thermal tracking error, and FIG. 2B shows a behavior of the compensation amount for the thermal tracking error;

FIG. 3 schematically shows the memory allocation; and

FIG. 4A shows a behavior of the compensation amount for the thermal tracking error against temperatures at the beginning of the lasing; and FIG. 4B shows the behavior of the compensation amount for the thermal tracking error at the end of the lasing.

### DESCRIPTION OF PREFERRED EMBODIMENTS

The present invention will be easily understood by taking the description below into account referring to accompanying drawings. Next, preferred embodiments of the invention will be described as referring to drawings. In the description, the same symbol or numeral will refer to the same element if possible.

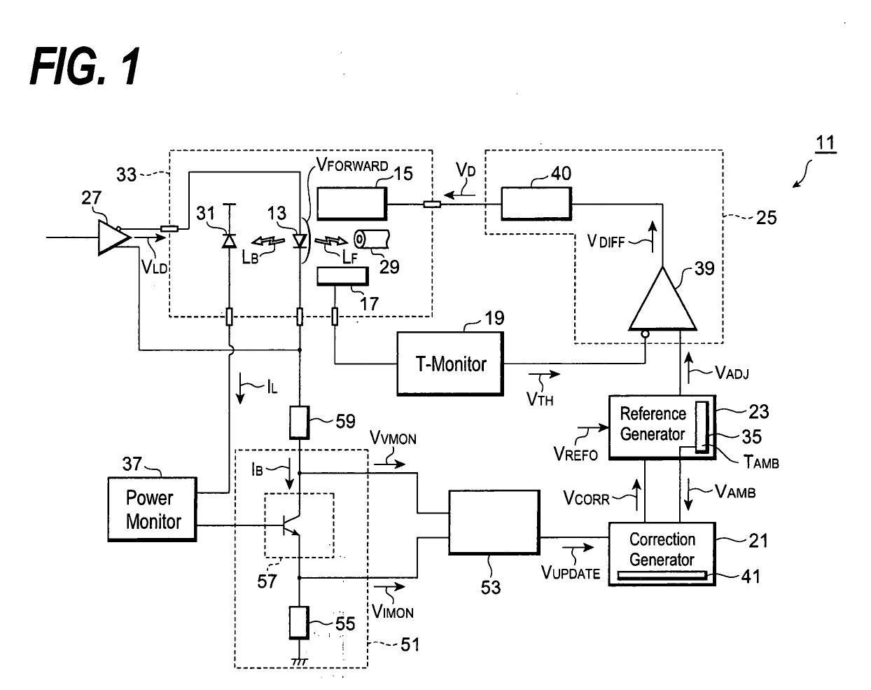

FIG. 1 is a block diagram of an optical transmitter according to the first embodiment of the invention. The optical transmitter 11 comprises a laser diode (LD) 13, a thermo-electric device 15 (hereinafter denoted as TEC), a temperature sensor 17, a block 19 for monitoring the temperature, a first generator 21 for a correction signal, a second generator 23 for a reference signal, and a temperature controller 25. The LD 13 generates optical outputs (L_{F}, L_{B}) by responding to a driving signal V_{LD} provided from the LD-Driver 27. A portion L_{F} of the output enters an optical fiber 29, while another portion L_{B} enters a light-receiving device 31 for monitoring the optical output of the LD. The LD may have a DFB (Distributed Feed-Back) type, a FP (Fabry Perot) type, or a VCSEL (Vertical Cavity Surface Emitting Laser) type. The TEC 15, which may be a Peltier Cooler, controls the temperature of the LD 13. The temperature sensor 17 may be a thermistor to monitor the temperature of the LD 13. The LD 13, the TEC 15, the temperature sensor 17, the light-receiving device 31 and the optical fiber 29 construct an optical module 33 installed within a package.

The block 19 for sensing the temperature connects the temperature sensor 17 to generate a first signal V_{TH} showing the temperature of the LD 13. The first generator 21 generates a correction signal V_{CORR} from the information to compensate the tracking error based on the second signal V_{AMB} that corresponds to the ambient temperature T_{AMB}. The second generator 23 includes a circuit for generating the second signal V_{AMB}, which is independent of the temperature sensor 17 to generate the first signal V_{TH}. The first generator 21 provides the correction signal corresponding to the second signal V_{AMB} to the second generator 23. The second generator 23 includes a circuit 35 for generating the second signal 23, and creates a reference signal V_{ADJ} by correcting a target signal V_{REF0}. As one embodiment, the target signal V_{REF0} may generated by the constant current source with a resister, or may created by using the digital-to-analog converter (D/A-C), either of which is independent of the ambient temperature and the power supply.

The present transmitter Varies the output V_{ADJ}, which should be intrinsically constant, as the ambient temperature changes so as to compensate the thermal tracking error, i.e., the discrepancy between the temperature indicated by the temperature sensor and the practical temperature of the LD. The first generator 21 generates the information how much the target value should be changed to compensate the tracking error, which is involved in the correction signal V_{CORR}.

The temperature controller 25 generates the driving signal V_{D} to drive the TEC 15 depending on the first signal V_{TH} and the reference signal V_{ADJ}, which is derived from the target signal V_{REF0} using the correction signal V_{CORR}, for example, V_{ADJ}=V_{REF0}+/−V_{CORR}. The temperature controller 25 operates to equalize the first signal V_{TH} with the reference signal V_{ADJ} by a feedback loop constituted by the comparator 39, the driver 40, the TEC 15, the temperature sensor 17, and the monitoring block 19. When the first signal V_{TH} is greater than the reference signal V_{ADJ}, the comparator 39, the driver 40, and the thermoelectric cooler 15 operates to reduce the first signal V_{TH}. Conversely, when the first signal V_{TH} is smaller than the reference signal V_{ADJ}, the feedback loop operates to raise the first signal V_{TH}.

The monitoring block 19 includes a resistor to bias the thermistor 17, which is capable of generating the voltage signal corresponding to the change of the resistance of the thermistor 17.

Within in the temperature controller 25, the comparator 29 receives the reference signal V_{ADJ} from the second generator and the first signal V_{TH} from the monitoring block 19, and generates a signal V_{DIFF} showing the difference between these two signals. The driver 40 generates the driving signal V_{D} depending on this difference signal V_{DIFF}. That is, the temperature controller 25 generates the driving signal V_{D} to drive the TEC from the reference signal V_{ADJ} and the first signal V_{TH}. The TEC 15 heats up or cools down the LD 13 based on the driving signal V_{D}. Changing the temperature of the TEC 15 by the driving signal V_{D}, the temperature sensor 17 senses this change, and the monitoring block 19 generates a revised first signal V_{TH} based on this change in the temperature of the TEC. The temperature controller 25 compares this revised first signal V_{TH} with the reference signal V_{ADJ} and corrects the driving signal V_{D} to reduce the discrepancy between the revised first signal V_{TH} and the reference signal V_{ADJ}. Since the reference signal V_{ADJ} is obtained by correcting the target signal V_{REF0} with the correction signal V_{CORR}, this feedback control for the temperature of the LD may escape from the thermal tracking error.

The TEC 15 is so controlled that the first signal V_{TH} becomes equal to the reference signal V_{ADJ} by the driver 40. This control becomes a negative feedback control with a thermal response therein. To increase the closed-loop gain may close the temperature of the LD to the target value when the feedback control becomes stable. Specifically, the comparator 39 may be a differential amplifier and the gain of this differential amplifier determines the closed-loop gain. The drive 40 may be configured to output a pulse-width-modulation (PWM) signal responding to the analog signal output from the differential amplifier.

The second generator sets the reference signal V_{ADJ} based on the target signal V_{REF0} corresponding to the target temperature of the LD, which is equivalent to get the desired emission wavelength of the LD 13. The target signal V_{REF0} means the target value when the temperature of the thermistor 17 becomes identical with that of the LD independent of the ambient temperature, namely, no tracking error has occurred. For example, assuming that the temperature of the LD and that of the thermistor 17, at which the desired emission wavelength may be obtained under the ambient temperature of 25° C., are 40° C. and 39.5° C., respectively, the reference signal V_{ADJ} output from the second generator to the controller becomes a value corresponding to the temperature of 39.5° C. Even when the ambient temperature becomes 70° C., the reference signal V_{ADJ} corresponds to the temperature of 39.5° C. as long as the temperature difference between the LD and the thermistor is maintained. However, the temperature difference actually depends on the thermal condition thereof. For example, assuming that the temperature of the LD becomes 39° C. as that of the thermistor is left 39.5° C. when the ambient temperature is 70° C., the temperature of the LD is maintained to 39° C., which is 1° C. below the desired target temperature 40° C., when the reference voltage V_{ADJ} is left to a value corresponding to the temperature of the thermistor being 39.5° C. The discrepancy of the temperature 1° C. is equivalent to 100 pico-meter (pm) in the emission wavelength of the LD, which is unacceptable shift in the dense wavelength division multiplexing (DWDM) communication system. The DWDM system allows only +/−50 pm shift in the wavelength.

The reference signal V_{ADJ} should be corrected to compensate this discrepancy in the temperature of the LD, i.e. in the emission wavelength. In the example above mentioned, when the temperature of the thermistor becomes 40.5° C. at the ambient temperature of 70° C., the temperature of the LD becomes the desired value 40° C. by adding the correction-signal V_{CORR} of 1° C. to the target value V_{REF0} corresponding to the temperature 39.5° C. to generate the revised reference signal V_{ADJ}.

The second generator 23 may install a temperature sensor on the substrate, where the second generator is installed, to monitor the ambient temperature, or may use a sensor built within the integrated circuit that operates as the second generator 23. The second generator 23 receives the correction signal V_{CORR} corresponding to the ambient temperature V_{AMB} from the first generator 21. The second signal V_{AMB} may be a voltage signal, or may be a digitized signal. The updating signal V_{UPDATE}, which is output from the correction block 53 and Varies as the long-term deterioration of the LD, operates independently of the second signal V_{AMB}.

The second generator 23 outputs the reference signal V_{ADJ} corrected by the correction signal V_{CORR} as the target signal for the feedback loop. The reference signal V_{ADJ} may be configured to be a voltage signal generated by a D/A-C, or by a digital potentiometer with a resistor and a constant current source. The reference signal V_{ADJ} may be renewed with a cycle of, for instance, 5 milliseconds by the sequence of, (1) generating the second signal V_{AMB} based on the monitored ambient temperature T_{AMB} and (2) correcting the target signal V_{REF0} with the correction signal V_{CORR} based on thus monitored second signal V_{AMB} under the control of the microprocessor.

The optical transmitter 11 encloses the LD 13, the light-receiving device such as a photodiode (PD) 31, the thermistor 17, and the thermo-electric device 15 within a package. The power monitoring block 37 maintains the optical output power of the LD 13 constant. Specifically, the PD 31 converts the back facet light-LB of the LD 13 into a current signal IL, and the power monitoring block 37 controls the bias current I_{B} of the LD to keep this current signal constant to a predetermined value, which is the so-called automatic power control (APC).

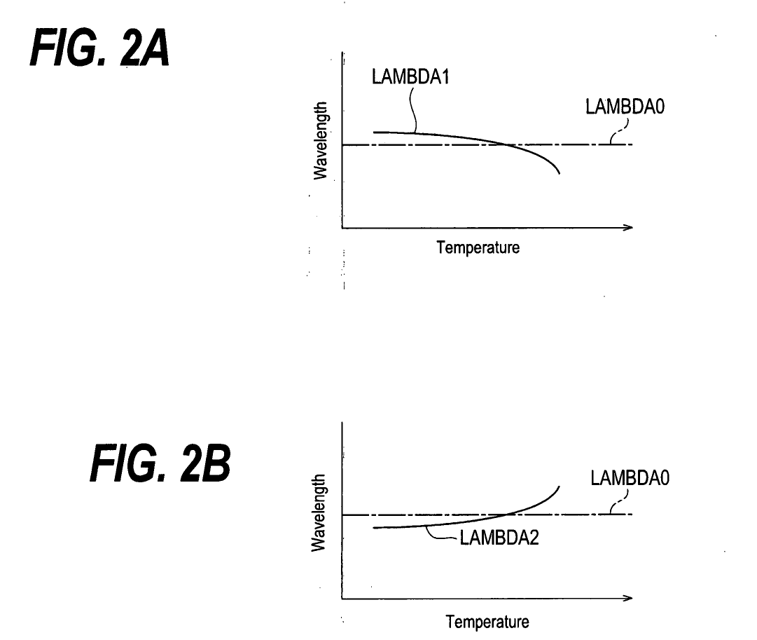

FIG. 2A schematically shows the emission wavelength of the LD including the thermal tracking error in a behavior LAMBDA1, while a behavior LAMBDA2 shows the amount of the compensation for the thermal tracking error. As shown in FIG. 2A, despite the desired emission wavelength LAMBDA0 is set and the thermo-electric device is operated to maintain this emission wavelength LAMBDA0 constant, the practical emission wavelength LAMBDA1 varies as the temperature changes due to the thermal tracking error. The amount to compensate this tracking error depends on the temperature as shown in FIG. 2B. The compensation amount may be stored in a configuration of a table, which is called as a lookup table.

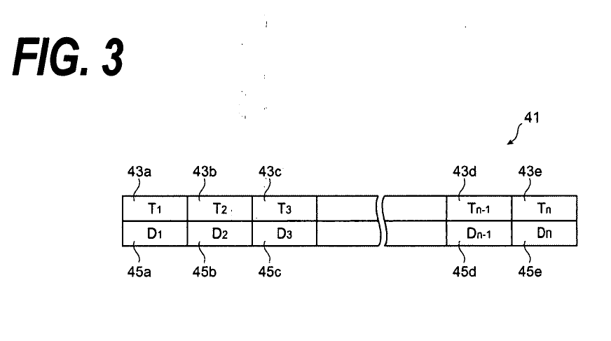

The first generator 21 provides the correction signal V_{CORR} depending on the second signal V_{AMB}, which corresponds to the behavior LAMBDA2 in FIG. 2B, to the second generator 23. The first generator 21 may install a memory 41 to store the correction signal V_{CORR} in connection with the second signal V_{AMB}. FIG. 3 shows an example of the architecture of the memory 41, which provides the allocation, 43A to 43E to store the information T₁ to Tₙ corresponding to the ambient temperature T_{AMB} and the allocation from 45A to 45E to store the correction signals, D₁ to Dₙ, in connection with the temperatures.

Referring to FIG. 1 again, the optical transmitter 11 may provide the bias driver 51 and the correction block 53. The bias driver 51 connects the LD 13 via an inductor 59, i.e., the inductor 59 is connected to the collector of the transistor 57. The base of the transistor 57 receives the current signal I_{L} from the PD 31 via the power monitoring block 37.

The bias driver 51 outputs the current monitoring signal V_{IMON} which corresponds to the magnitude of the bias current I_{B} provided for the LD 13. The correction block 53 outputs the updating signal V_{UPDATE} based on this current monitoring signal V_{IMON} to renew the correction signal V_{CORR}. The bias current I_{B} for the LD 13 operated under the APC loop gradually increases to obtain the constant output power by the long-term deterioration of the LD 13. The emission wavelength changes as the increase of the bias current I_{B} because the rate of the temperature increase and the number of carriers within the active layer of the LD depends on the bias current I_{B}. The change of the wavelength due to these phenomena becomes typically from +5 to +10 pm/mA. Therefore, even when the emission wavelength of the LD shifts due to the increase of the bias current to compensate the decrease of the optical output power, to control the temperature of the LD may correct this shift in the emission wavelength. This compensation of the long-term deterioration of the LD may be carried out by adding an offset parameter based on the increase of the bias current I_{B} into the lookup table for correcting the tracking error. Accordingly, the optical transmitter may be realized that shows no shift in the emission wavelength and no fluctuation in the optical output power operated under any ambient temperature in longtime. The current monitoring signal V_{IMON} may be obtained by monitoring a voltage drop at the resistor 55 due to the bias current I_{B}, the updating signal V_{UPDATE} includes the offset amount to revise the lookup table for the tracking error.

The first generator 21 revises the lookup table in accordance with the updating signal V_{UPDATE}, which means that the correction signals, D₁ to D_{N}, stored in the lookup table are rewritten to a new set of correction signals, D₁′ to D_{N}′, which are added by the updating signal V_{UPDATE}.

The intrinsic resistance of the LD gradually increases as the long-term deterioration progresses, which causes the increase of the forward voltage of the LD. The increase of the intrinsic resistance also brings the rising of the power consumption thereof, which means the much heat is generated and the LD is raises in the temperature thereof, consequently, it cases the shift in the emission wavelength. The bias driver 51 may outputs the voltage monitoring signal V_{VMON} to the correction block 53. The voltage monitoring signal V_{VMON} corresponds to the forward voltage of the LD 13. The correction block 53, by receiving this voltage monitoring signal V_{VMON}, may generate the updating signal in connection with this voltage monitoring signal V_{VMON}. The bias drive 51 may output both the current and voltage monitoring signals, V_{IMON} and V_{VMON}. In such case, the correction block 53 may calculate the offset to be sent to the first generator based on these two parameters, V_{IMON} and V_{VMON}.

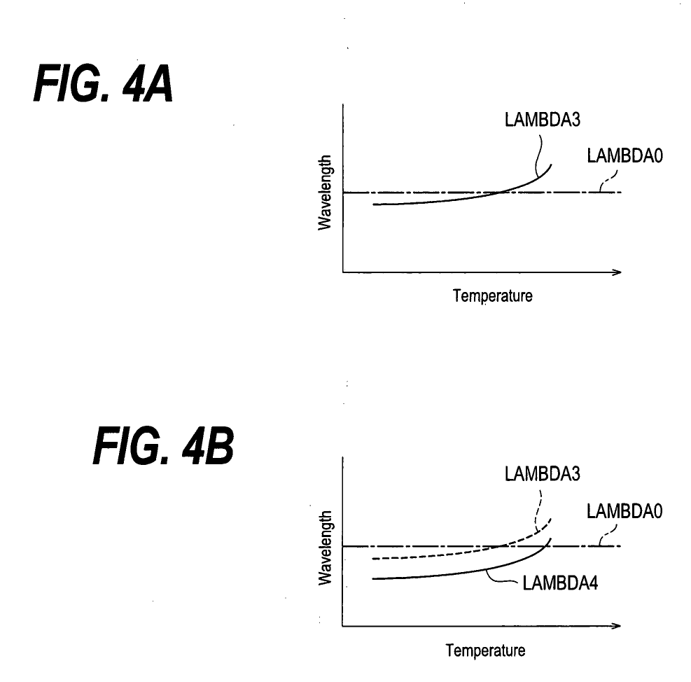

FIG. 4A shows the behavior LAMBDA3 for compensating the thermal tracking error at the begging of the operation. The behavior LAMBDA4 appeared in FIG. 4B corresponds to the compensation for the tracking error influenced by the long-term deterioration of the LD. As shown in FIG. 4B, the characteristic of the optical transmitter shifts from the behavior LAMBDA3 to the behavior LAMBDA4 as the accumulative time increases. This shift from LAMBDA3 to LAMBDA4 may be carried out by rewriting the lookup table as described above.

The bias current I_{B} to get the constant optical output power from the LD increases due to the long-term deterioration thereof. In other words, to increase the bias current I_{B} may output the optical power same as that at the beginning of lasing (BOL). The forward voltage V_{FORWARD} of the LD reflects the change of the intrinsic resistance of the LD. However, this change in the resistance may not detected by monitoring the temperature of the LD nor by monitoring the increase of the bias current I_{B}. Accordingly, the condition of the LD, in particular, the deteriorating condition of the LD may be evaluated by monitoring both the bias current I_{B} and the forward voltage V_{FORWARD}.

This estimation of the deterioration, namely the offset amount, may be simply calculated in a first approximation as follows: [symbol]
_{OFF}=a*(V_{IF}−V_{IF}⁽⁰⁾+b*(V_{VF}−V_{VF}⁽⁰⁾).
Where, V_{IF} and V_{IF}⁽⁰⁾ correspond to the present bias current and the initial, at the BOL, bias current, respectively, while V_{VF} and V_{VF}⁽⁰⁾ correspond to the present and the initial forward voltage, and a and b are constants. Parameters, a, b, V_{IF}⁽⁰⁾, and V_{VF}⁽⁰⁾, necessary to the calculation may be stored in the memory 41.

The bias current I_{B} may be calculated by I_{B}=V_{IMON}/R, where R is the resistance of the resistor 55, while the forward voltage V_{FORWARD} of the LD may be obtained by V_{FORWARD}=V_{ad}−V_{VMON}, where V_{ad} is the anode voltage of the LD 13. Obtaining the bias current I_{B} and the forward voltage V_{FORWARD} at the BOL, for instance, at the delivery testing, calculating the initial parameters, V_{IF}⁽⁰⁾ and V_{VF}⁽⁰⁾, as mentioned above, and storing these parameters with constants, a and b, within the memory 41, the offset amount [symbol] _{OFF} may be obtained by monitoring two parameters, V_{IMON} and V_{VMON}, at any time after the operation of the transmitter. Tow parameters, a and b, may be evaluated by the linear approximation. That is, the parameter a may be evaluated by monitoring the shift in the emission wavelength as increasing the bias current I_{B}, and reduces the change of the temperature in accordance with the relation, 0.1 nm/° C. The other parameter b may be evaluated by monitoring the shift in the emission wavelength as increasing the forward voltage V_{FORWARD} of the LD, and converting the result to the temperature change in accordance with the above relation. Thus, the correction in the temperature of the LD for the long-term deterioration can be evaluated.

The lookup table is rewritten by this correction [symbol] _{OFF}, namely, LUT (T)_{UPDATE}=LUT (T)⁽⁰⁾+ [symbol] _{OFF}. Parameters, a and b, may be optionally selected. For example, the correction is preformed based only on the voltage monitoring signal V_{VMON} when a=0, while the correction is carried out based only on the current monitoring signal V_{IMON} when b=0.

The rewriting of the lookup table is carried out, for example, every 5 millisecond. The timing of the rewriting is preferable not to be identical with the access of the second generator 23 to the memory 41 in the first generator 21. The initial value of the lookup table LUT (T) (0) is determined by the performance of the LD at the BOL. The lookup table LUT(T) may be revised by the offset value calculated by the foregoing procedure until the end of the lasing (EOL).

When the correction signal V_{CORR} may be expressed by an nth polynomial, coefficients, Aₙ, Aₙ₋₁, . . . , A₀, of the polynomial are stored in the memory in advance to the practical operation of the LD, the correction signal for the present ambient temperature, V_{AMB}, can be obtained by using this polynomial and the coefficients thereof as:
V_{CORR}(V_{AMB})=Aₙ*V_{AMB}+Aₙ₋₁*V_{AMB}ⁿ⁻¹+ . . . +A₁*V_{AMB}+A₀.

Further precise correction for the long-term deterioration of the LD may be obtained by:
V_{CORR}(V_{AMB})=LUT(V_{AMB})+DG(V_{IMON},V_{VMON}),
where DG(V_{IMON}, V_{VMON}) is a multivariable function.

While the invention has been described in terms of preferred embodiments, those skilled in the art will recognize that the invention can be practiced with modification within the spirit and scope of the appended claims.

What is claimed is:

1. An optical transmitter, comprising:
a laser diode for emitting light with an emission wavelength at a temperature;
a temperature sensor for detecting the temperature of the laser diode;
a thermoelectric device for controlling the temperature of the laser diode;
a first generator for generating a reference temperature;
a temperature controller for controlling the thermo-electric device to coincide the temperature of the laser diode with the reference temperature; and
a second generator for generating a correction temperature based on an ambient temperature,
wherein the reference temperature is corrected by the correction temperature to compensate a thermal tracking error of the laser diode with respect to the ambient temperature.

2. The optical transmitter according to claim 1,
wherein the second generator provides a table for storing the correction temperature with respect to the ambient temperature.

3. The optical transmitter according to claim 2,
further comprises a bias driver for providing a bias current to the laser diode, the bias driver outputting a current monitoring signal corresponding to the bias current to the second generator,
wherein the second generator is configured to renew the table based on the current monitoring signal.

4. The optical transmitter according to claim 2, further comprises a bias driver for providing a bias current to the laser diode, the bias driver outputting a voltage monitoring signal corresponding to a forward bias voltage of the laser diode to the second generator,
wherein the second generator is configured to renew the table based on the voltage monitoring signal.

5. The optical transmitter according to claim 4,
wherein the bias driver further outputs a current monitoring signal corresponding to the bias current to the second generator, and
the second generator is configured to renew the table based on the voltage monitoring signal and the current monitoring signal.

6. A method for controlling a laser diode in an optical transmitter that includes a thermo-electric device for changing a temperature of the laser diode, a temperature sensor for monitoring the temperature of the laser diode, a first generator for generating a reference temperature, a second generator for generating a correction temperature, and a temperature controller for controlling the thermo-electric device to coincide the temperature of the laser diode with the reference temperature, the method comprising steps of:
setting a target temperature in the first generator;
generating the correction temperature based on an ambient temperature;
calculating the reference temperature from the target temperature and the correction temperature; and
controlling the temperature of the thermo-electric device so as to coincide with the reference temperature.

7. The method according to claim 6,
wherein the second generator includes a table for storing the correction temperature with respect to the ambient temperature, and
the step for generating the correction temperature includes a step for reading the correction temperature from the table.

8. The method according to claim 7,
wherein the optical transmitter further includes a bias driver for providing a bias current to the laser diode and outputting a current monitoring signal corresponding to the bias current to the second generator, and
the method further comprises a step for renewing the table based on the current monitoring signal.

9. The method according to claim 8,
wherein the step for rewriting the table is carried out by calculating a difference in the bias current between a present magnitude and a magnitude at the beginning of the lasing.

10. The method according to claim 7,
wherein the optical transmitter further includes a bias driver for providing a bias current to the laser diode and outputting a voltage monitoring signal corresponding to a forward bias voltage of the laser diode to the second generator, and
the method further comprises a step for renewing the table based on the voltage monitoring signal.

11. The method according to claim 10,
wherein the step for rewriting the table is carried out by calculating a difference in the forward bias voltage between a present magnitude and a magnitude at the beginning of the lasing.

12. The method according to claim 6,
wherein the second generator includes a table for storing the correction temperature with respect to the ambient temperature, and
the step for generating the correction temperature includes a step for calculating the correction temperature based on a nth polynomial by using variables stored in the table and the ambient temperature.
